(19) United States
(12) Patent Application Publication
(10) Pub. No.: US 2016/0086195 A1
(43) Pub. Date: Mar. 24, 2016

(54) DETERMINE A COMPANY RANK UTILIZING ON-LINE SOCIAL NETWORK DATA

(71) Applicant: LinkedIn Corporation, Mountain View, CA (US)

(72) Inventors: Vitaly Gordon, Mountain View, CA (US); Navneet Kapur, Sunnyvale, CA (US); Ada Cheuk Ying Yu, Santa Clara, CA (US)

(21) Appl. No.: 14/494,402

(22) Filed: Sep. 23, 2014

(51) Int. Cl. G06Q 30/02; G06Q 50/00

(52) U.S. Cl. CPC G06Q 30/0201; G06Q 50/01

(57) ABSTRACT

Method and system to determine a company rank utilizing on-line social network data is described. A company ranking system may examine member profiles representing respective members of an on-line social network system and extract transition data. From the transition data, the company ranking system may construct a company transition graph having nodes that represent respective companies and edges that represent transitions of employees from one company to another. A rank or a node score for each node of the company transition graph may be determined by applying a ranking algorithm to the graph. The scores generated for respective nodes in the company transition graph may be stored for future use in a database.

### TECHNICAL FIELD

This application relates to the technical fields of software and/or hardware technology and, in one example embodiment, to system and method to determine a company rank utilizing on-line social network.

### BACKGROUND

An on-line social network may be viewed as a platform to connect people in virtual space. An on-line social network may be a web-based platform, such as, e.g., a social networking web site, and may be accessed by a use via a web browser or via a mobile application provided on a mobile phone, a tablet, etc. An on-line social network may be a business-focused social network that is designed specifically for the business community, where registered members establish and document networks of people they know and trust professionally. Each registered member may be represented by a member profile. A member profile may be include one or more web pages, or a structured representation of the member's information in XML (Extensible Markup Language), JSON (JavaScript Object Notation), etc. A member's profile web page of a social networking web site may emphasize employment history and education of the associated member.

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example method and system to determine a company rank utilizing on-line social network data may be implemented;

FIG. 2 is block diagram of a system to determine a company rank utilizing on-line social network data, in accordance with one example embodiment;

FIG. 3 is a flow chart of a method to determine a company rank utilizing on-line social network data, in accordance with an example embodiment.

FIG. 4 is a diagrammatic representation of an example machine in the form of a computer system within which a set of instructions, for causing the machine to perform any one or more of the methodologies discussed herein, may be executed.

### DETAILED DESCRIPTION

A method and system to determine a company rank utilizing on-line social network data is described. In the following description, for purposes of explanation, numerous specific details are set forth in order to provide a thorough understanding of an embodiment of the present invention. It will be evident, however, to one skilled in the art that the present invention may be practiced without these specific details.

As used herein, the term “or” may be construed in either an inclusive or exclusive sense. Similarly, the term “exemplary” is merely to mean an example of something or an exemplar and not necessarily a preferred or ideal means of accomplishing a goal. Additionally, although various exemplary embodiments discussed below may utilize Java-based servers and related environments, the embodiments are given merely for clarity in disclosure. Thus, any type of server environment, including various system architectures, may employ various embodiments of the application-centric resources system and method described herein and is considered as being within a scope of the present invention.

For the purposes of this description the phrase “an on-line social networking application” may be referred to as and used interchangeably with the phrase “an on-line social network” or merely “a social network.” It will also be noted that an on-line social network may be any type of an on-line social network, such as, e.g., a professional network, an interest-based network, or any on-line networking system that permits users to join as registered members. For the purposes of this description, registered members of an on-line social network may be referred to as simply members.

Each member of an on-line social network is represented by a member profile (also referred to as a profile of a member or simply a profile). The profile information of a social network member may include personal information such as, e.g., the name of the member, current and previous geographic location of the member, current and previous employment information of the member, information related to education of the member, information about professional accomplishments of the member, publications, patents, etc. The profile information of a social network member may also include information about the member's professional skills, such as, e.g., “product management,” “patent prosecution,” “image processing,” etc.). The profile of a member may also include information about the member's current and past employment, such as company identifications, professional titles held by the associated member at the respective companies, as well as the member's dates of employment at those companies.

In one embodiment, a determination of a company rank may be made utilizing so-called inflows and outflows of people with respect to companies that are being ranked. Companies that tend to attract people, e.g., those companies to which people tend to transition from other companies, are identified as higher ranking companies, as opposed to those companies, to which none or fewer people tend to transition from other companies, which are identified as lower ranking companies.

For the purposes of this description, a computer-implemented system for determining respective ranks for companies represented by items in an electronically-stored set (a set of companies) may be referred to as a company ranking system. In order to generate respective rankings or scores for a set of companies, a company ranking system may be configured to utilize a social network system that focuses on professional profiles of its members. In one embodiment, a company ranking system may be configured to examine member profiles representing respective members of the on-line social network system and extract so-called transition data. An item in the transition data indicates transition, of a member of the on-line social network system, from one company to another company. A company ranking system may access a member profile, determine, from the employment section of the profile, that a person represented by the member profile left company A and joined company B, and increment a count of employees who transitioned from company A to company B. This process of extracting transition data may continue until all profiles (or a predetermined subset of profiles in the social network system) have been examined. In some embodiments, a subset of profiles may be selected based on a particular industry. For example, a company ranking system may be configured to select for examination only those profiles that have been identified as associated with high tech industry. Thus extracted transition data may be then used to rank companies that have been identified as high tech companies. In one embodiment, the profiles that are being examined to determine a company rank may be selected based on a certain criteria, such as a particular industry, e.g., high tech, banking, architecture, etc.

Transition data may be processed to determine, which companies are more desirable and which companies are less desirable. From the transition data, a company ranking system may derive further data such as how many employees transitioned to the company from other companies during a period of time termed a target period (e.g., one year or the past three years, or some other period) and also how many employees remained with the company for the entire target period.

A company ranking system may then construct a so-called company transition graph having nodes that represent respective companies and edges that represent transitions of employees from one company to another. An edge has a direction from one node (e.g., node A representing company A) to another node (e.g., node B representing company B), if transition data indicates that more employees moved from company A to company B than from company B to company A. For example, if there are nine people that left company A to work for company B and one person that left company B to work for company A, the edge from node A to node B would be assigned a weight of 90%, which represents that 90% of the people who are moving between these two companies A and B are moving from company A to company B. In another embodiment, a weight assigned to an edge connecting a first node and a second node is based on the number of employees that transitioned from the first company to the second company and/or the number of employees transitioned from the second company to the first company. For example, if 10 people moved from company A represented by node A to company B represented by node B and 15 people moved from company B to company A, the directed edge from node B to node A would be given a weight of 5. In one embodiment, the edges in a company transition graph are created only between nodes that represent companies that have a so-called employee transition relationship. For example, if no employees moved from company A to company B or from company B to company A during the target period, there would not be an edge connecting A and B in the company transition graph.

A rank or a node score for each node of the company transition graph may be determined by applying a ranking algorithm to the graph, such as, for example, PageRank algorithm. A node score for a node in the company transition graph indicates a likelihood that a member of the on-line network system transitions to a company represented by that node. A node score can be a value between 0 and 1 and the sum of all node scores in a company transition graph equals to 1. The node score of a node is indicative of a projected size of a company represented by the node at a future time, provided that the same transitioning trend of employees continues. In one embodiment, a company ranking system may calculate a projected size value for each node in the company transition graph. A projected size value for a node may be determined by multiplying the node score of the node by the number of member profiles that have been examined in order to construct the company transition graph. For example, if the number of all member profiles that are being considered in constructing the company transition graph is 30M and the node score for node A representing company A is one percent, the projected size of company A would be 1% of 30M, which is 3M.

In some embodiments, various scores generated for a node in the company transition graph may include, e.g., the difference between the current size and the projected size of a company represented by the node, the ratio of the current size and the projected size of the company, a value that indicates the ratio or the difference between the current size and the projected size of the company as compared to companies represented by other nodes in the company transition graph. The scores generated for respective nodes in the company transition graph may also be referred to as company scores.

In one embodiment, a score generated for a node representing a company may be boosted by a value affected by the number of people who remained employed at the company during the target/sample period of time or during a certain predetermined period of time. For example, for every person who remains employed the company for a year, the rank of the node that represents that company is increased. The number of people staying at the company may be represented by a self-loop type of edge in the transition graph.

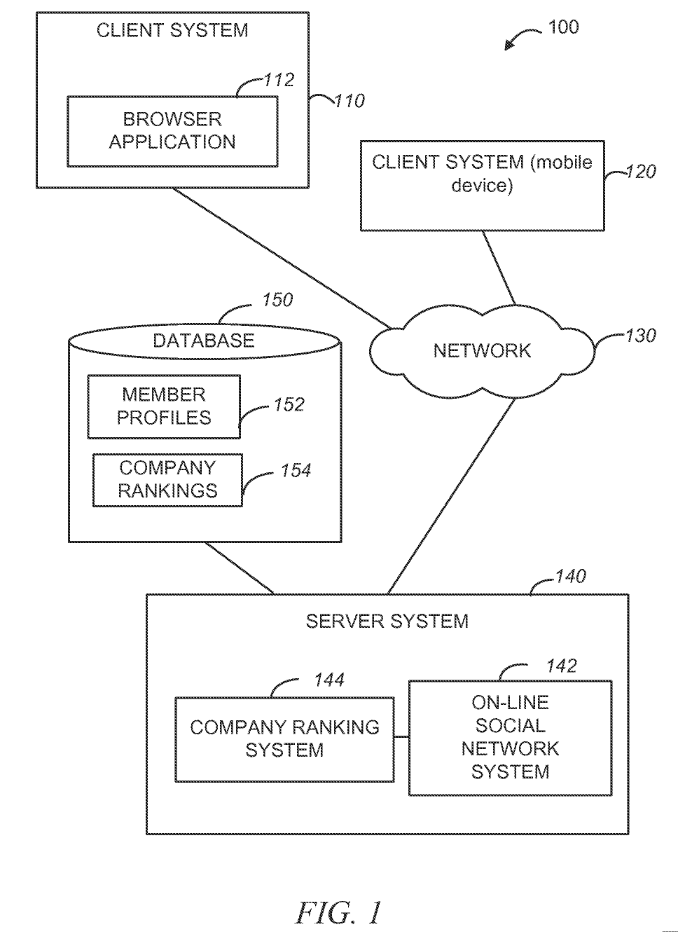

Company scores may be stored for future use in a database and may be used for various purposes, such as, e.g., estimating salary of an employee of a particular company, determining a degree of success to be attributed to a member based on respective rankings of companies at which the member has been employed, determining a rank of a university based on the percentage of that university's graduates that become employees of the tope-scored companies, etc. Example method and system to determine a company rank utilizing on-line social network data may be implemented in the context of a network environment 100 illustrated in FIG. 1.

As shown in FIG. 1, the network environment 100 may include client systems 110 and 120 and a server system 140. The client system 120 may be a mobile device, such as, e.g., a mobile phone or a tablet. The server system 140, in one example embodiment, may host an on-line social network system 142. As explained above, each member of an on-line social network is represented by a member profile that contains personal and professional information about the member and that may be associated with social links that indicate the member's connection to other member profiles in the on-line social network. Member profiles and related information may be stored in a database 150 as member profiles 152.

The client systems 110 and 120 may be capable of accessing the server system 140 via a communications network 130, utilizing, e.g., a browser application 112 executing on the client system 110, or a mobile application executing on the client system 120. The communications network 130 may be a public network (e.g., the Internet, a mobile communication network, or any other network capable of communicating digital data). As shown in FIG. 1, the server system 140 also hosts a company ranking system 144 that may be utilized beneficially to determine respective company rankings (also referred to as company scores) for companies represented by items in one or more electronically-stored sets of company identifiers (also referred to as sets of companies). The company ranking system 144 may be configured to utilize the social network 142 to determine rankings (also referred to as company scores) for various companies. The company ranking system 144 examines member profiles representing respective members of the on-line social network system and extracts transition data. As explained above, an item in the transition data indicates transition, of a member of the on-line social network system 142, from one company to another company. The profiles may be selected for examination based on a particular industry. From the transition data, the company ranking system 144 may derive further data such as how many employees transitioned to the company from other companies during a target period of time and also how many employees remained with the company for the entire target period.

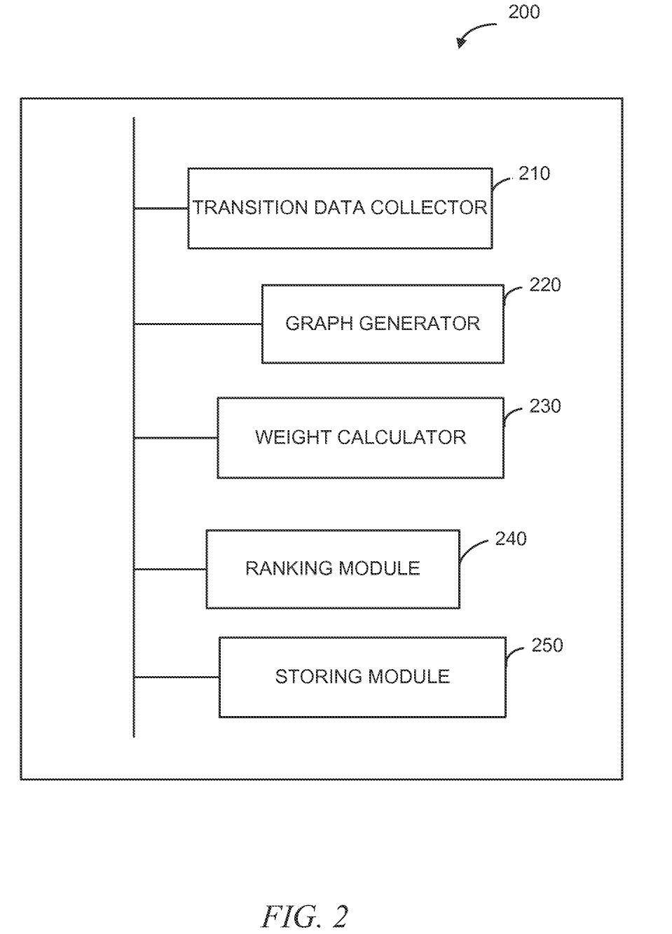

The company ranking system 144 may be configured to construct a company transition graph having nodes that represent respective companies and edges that represent transitions of employees from one company to another. As stated above, an edge has a direction from one node (e.g., node A representing company A) to another node (e.g., node B representing company B), if transition data indicates that more employees moved from company A to company B than from company B to company A. A rank or a node score for each node of the company transition graph may be determined by applying a ranking algorithm to the graph, such as, for example, PageRank algorithm. As stated earlier, a node score for a node in the company transition graph indicates a likelihood that a member of the on-line network system transitions to a company represented by that node and can be a value between 0 and 1, where the sum of all node scores in a company transition graph equals to 1. The node scores may be used to generate further values, such as, e.g. the difference between the current size and the projected size of a company represented by the node, the ratio of the current size and the projected size of the company, etc. The scores generated, also referred to as company scores, may be stored for future use in the database 150 as company rankings 154. An example company ranking system 144 is illustrated in FIG. 2.

FIG. 2 is a block diagram of a system 200 to determine a company rank utilizing on-line social network data, in accordance with one example embodiment. As shown in FIG. 2, the system 200 includes a transition data collector 210, a graph generator 220, a weight calculator 230, a ranking module 240, and a storing module 250. The transition data collector 210 may be configured to extract transition data from a set of member profiles. A member profile from the set of member profiles representing a member of the on-line social network system 142 of FIG. 1. The transition data collector 210 may be configured to select the set of member profiles from all member profiles maintained in the on-line social network system 142, based on a type of industry. An item of the transition data indicates transition of the member from a first company to a second company.

The graph generator 220 may be configured to generate a company transition graph utilizing the transition data. The nodes in the company transition graph represent respective companies from the set of companies and the edges connecting two nodes the company transition graph indicate that one or more members transitioned from a first company represented by the first node to a second company represented by the second node. The weight calculator 230 may be configured to assign a weight to the edge connecting the first node and the second node. The weight of an edge may reflect a number of members transitioned from the first company to the second company.

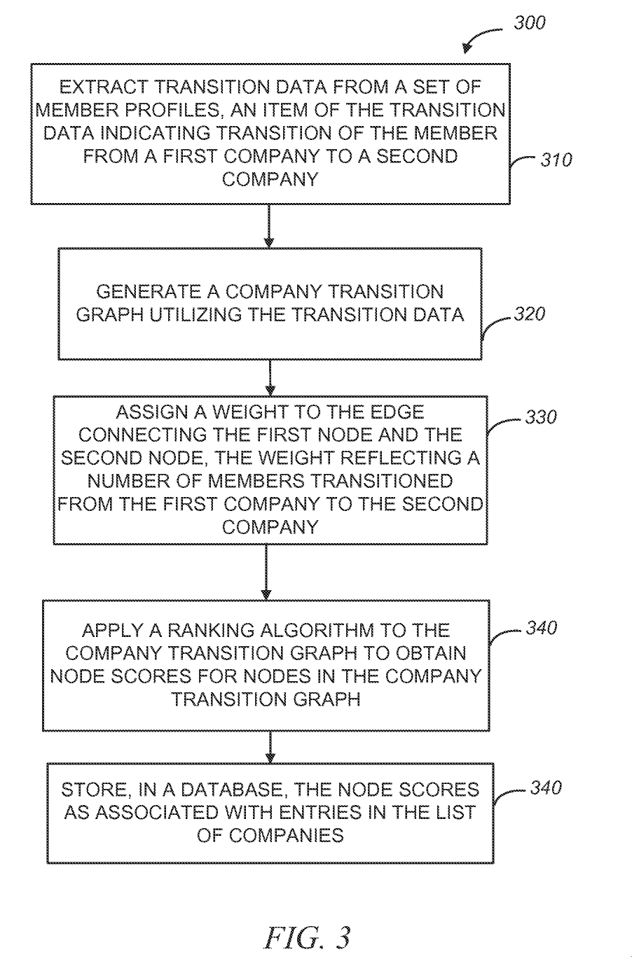

The ranking module 240 may be configured to apply a ranking algorithm, such as, e.g., PageRank algorithm, to the company transition graph to obtain node scores for nodes in the company transition graph. The ranking module 240 may also be configured to generate a projected size value for a node by multiplying the node score for the node by a number of items in the set of member profiles that have been examined by the transition data collector 210. The ranking module 240 may further be configured to determine, for an item in the set of companies, a value indicative of a number of employees that remained, at a company represented by the item in the list of companies, for a certain period of time. The storing module 250 may be configured to store, in a database, the node scores as associated with entries in the list of companies. Some operations performed by the system 200 may be described with reference to FIG. 3.

FIG. 3 is a flow chart of a method 300 to determine a company rank utilizing on-line social network data to a social network member, according to one example embodiment. The method 300 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the server system 140 of FIG. 1 and, specifically, at the system 200 shown in FIG. 2.

As shown in FIG. 3, the method 300 commences at operation 310, when the transition data collector 210 of FIG. 2 extracts transition data from a set of member profiles maintained by the on-line social network system 142 of FIG. 1. As explained above, an item of the transition data indicates transition of the member from a first company to a second company. At operation 320, the graph generator 220 of FIG. 2 generates a company transition graph utilizing the transition data. The nodes in the company transition graph represent respective companies from the set of companies and the edges connecting two nodes the company transition graph indicate that one or more members transitioned from a first company represented by the first node to a second company represented by the second node. At operation 330, the weight calculator 230 of FIG. 2 assigns a weight to respective edges connecting nodes in the company transition graph. The weight of an edge may reflect a number of members transitioned from the first company to the second company.

At operation 340, the ranking module 240 of FIG. 2 applies a ranking algorithm, such as, e.g., PageRank algorithm, to the company transition graph to obtain node scores for nodes in the company transition graph. The storing module 250 of FIG. 2 stores, for future use, the node scores as associated with entries in the list of companies.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

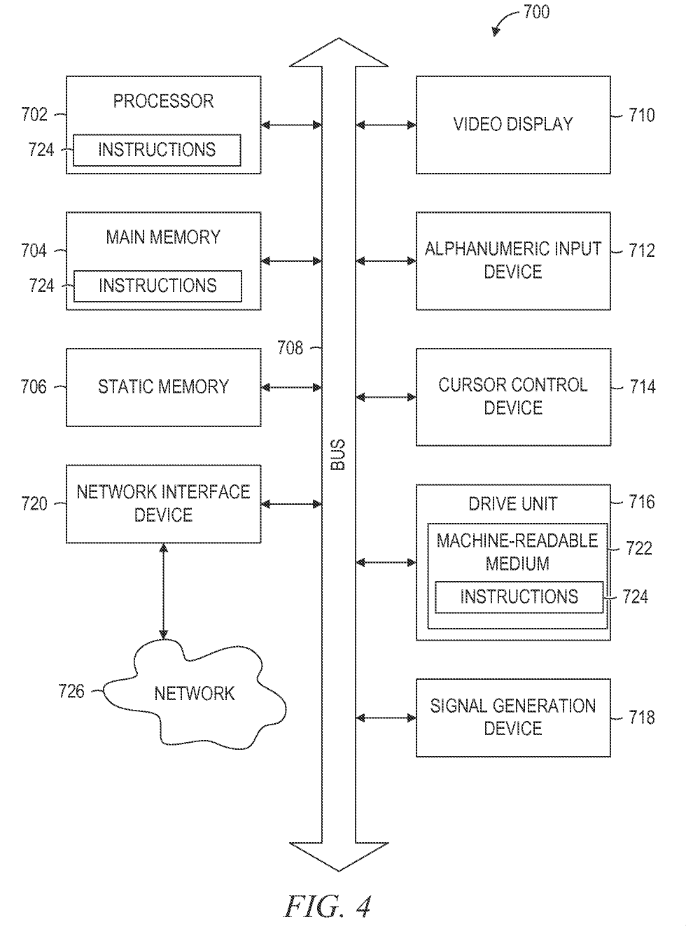

FIG. 4 is a diagrammatic representation of a machine in the example form of a computer system 700 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU) or both), a main memory 704 and a static memory 706, which communicate with each other via a bus 707. The computer system 700 may further include a video display unit 710 (e.g., a liquid crystal display (LCD) or a cathode ray tube (CRT)). The computer system 700 also includes an alpha-numeric input device 712 (e.g., a keyboard), a user interface (UI) navigation device 714 (e.g., a cursor control device), a disk drive unit 716, a signal generation device 718 (e.g., a speaker) and a network interface device 720.

The disk drive unit 716 includes a machine-readable medium 722 on which is stored one or more sets of instructions and data structures (e.g., software 724) embodying or utilized by any one or more of the methodologies or functions described herein. The software 724 may also reside, completely or at least partially, within the main memory 704 and/or within the processor 702 during execution thereof by the computer system 700, with the main memory 704 and the processor 702 also constituting machine-readable media.

The software 724 may further be transmitted or received over a network 726 via the network interface device 720 utilizing any one of a number of well-known transfer protocols (e.g., Hyper Text Transfer Protocol (HTTP)).

While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

Thus, method and system to determine a company rank utilizing on-line social network data have been described. Although embodiments have been described with reference to specific example embodiments, it will be evident that various modifications and changes may be made to these embodiments without departing from the broader scope of the inventive subject matter. Accordingly, the specification and drawings are to be regarded in an illustrative rather than a restrictive sense.

1. A computer-implemented method comprising:
extracting transition data from a set of member profiles, a member profile from the set of member profiles representing a member of an on-line social network system, an item of the transition data indicating transition of the member from a first company to a second company, the first company and the second company being from a set of companies;
utilizing the transition data for generating a company transition graph, using at least one processor, nodes in the company transition graph representing respective companies from the set of companies, an edge connecting a first node and a second node in the company transition graph indicating that one or more members transitioned from a first company represented by the first node to a second company represented by the second node;
assigning a weight to the edge connecting the first node and the second node, the weight reflecting a number of members transitioned from the first company to the second company;
applying a ranking algorithm to the company transition graph to obtain node scores for nodes in the company transition graph, a node score for a certain node from the nodes in the company transition graph indicating a likelihood that a member represented by a member profile in the on-line social network system transitions to a company represented by the certain node; and
storing, in a database, the node scores as associated with entries in the list of companies.

2. The method of claim 1, wherein a node score from the node scores is a value between zero and one, and the sum of all node scores in the company transition graph equals one.

3. The method of claim 1, wherein a node score for a node in the company transition graph is indicative of a projected size of a company represented by that node.

4. The method of claim 3, comprising generating a projected size value for the node by multiplying the node score for the node by a number of items in the set of member profiles.

5. The method of claim 1, comprising determining, for an item in the set of companies, a value indicative of a number of employees that remained, at a company represented by the item in the list of companies, for a certain period of time.

6. The method of claim 5, comprising representing the number of employees that remained, at a company represented by the item in the list of companies, for a certain period of time, by a self-loop type of edge in the company transition graph.

7. The method of claim 1, wherein the extracting of the transition data comprises determining, from an employment section of a profile from the set of member profiles, that a member represented by the profile transitioned from the first company to the second company.

8. The method of claim 1, comprising selecting the set of member profiles from all member profiles maintained in the on-line social network system, based on a type of industry.

9. The method of claim 1, comprising utilizing the node scores to estimate a salary of an employee of the first company.

10. The method of claim 1, comprising utilizing the node scores to calculate a rank of a university, based on a percentage of that university's graduates that became employees of the first company.

11. A computer-implemented system comprising:
a transition data collector, implemented using at least one processor, to extract transition data from a set of member profiles, a member profile from the set of member profiles representing a member of an on-line social network system, an item of the transition data indicating transition of the member from a first company to a second company, the first company and the second company being from a set of companies;
a graph generator, implemented using at least one processor, to generate a company transition graph utilizing the transition data, nodes in the company transition graph representing respective companies from the set of companies, an edge connecting a first node and a second node in the company transition graph indicating that one or more members transitioned from a first company represented by the first node to a second company represented by the second node;
a weight calculator, implemented using at least one processor, to assign a weight to the edge connecting the first node and the second node, the weight reflecting a number of members transitioned from the first company to the second company;
a ranking module, implemented using at least one processor, to apply a ranking algorithm to the company transition graph to obtain node scores for nodes in the company transition graph, a node score for a certain node from the nodes in the company transition graph indicating a likelihood that a member represented by a member profile in the on-line social network system transitions to a company represented by the certain node; and
a storing module, implemented using at least one processor, to store, in a database, the node scores as associated with entries in the list of companies.

12. The system of claim 11, wherein a node score from the node scores is a value between zero and one, and the sum of all node scores in the company transition graph equals one.

13. The system of claim 11, wherein a node score for a node in the company transition graph is indicative of a projected size of a company represented by that node.

14. The system of claim 13, wherein the ranking module is to generate a projected size value for the node by multiplying the node score for the node by a number of items in the set of member profiles.

15. The system of claim 11, wherein the ranking module is to determine, for an item in the set of companies, a value indicative of a number of employees that remained, at a company represented by the item in the list of companies, for a certain period of time.

16. The system of claim 15, wherein the graph generator is to represent the number of employees that remained, at a company represented by the item in the list of companies, for a certain period of time, by a self-loop type of edge in the company transition graph.

17. The system of claim 11, wherein the transition data collector is to determine, from an employment section of a profile from the set of member profiles, that a member represented by the profile transitioned from the first company to the second company.

18. The system of claim 11, wherein the transition data collector is to select the set of member profiles from all member profiles maintained in the on-line social network system, based on a type of industry.

19. The system of claim 11, comprising a school ranking system to calculate a rank of a university, based on a percentage of that university's graduates that became employees of the first company.

20. A machine-readable non-transitory storage medium having instruction data executable by a machine to cause the machine to perform operations comprising:
extracting transition data from a set of member profiles, a member profile from the set of member profiles representing a member of an on-line social network system, an item of the transition data indicating transition of the member from a first company to a second company, the first company and the second company being from a set of companies;
utilizing the transition data for generating a company transition graph, nodes in the company transition graph representing respective companies from the set of companies, an edge connecting a first node and a second node in the company transition graph indicating that one or more members transitioned from a first company represented by the first node to a second company represented by the second node;
assigning a weight to the edge connecting the first node and the second node, the weight reflecting a number of members transitioned from the first company to the second company;
applying a ranking algorithm to the company transition graph to obtain node scores for nodes in the company transition graph, a node score for a certain node from the nodes in the company transition graph indicating a likelihood that a member represented by a member profile in the on-line social network system transitions to a company represented by the certain node; and
storing, in a database, the node scores as associated with entries in the list of companies.
